(19) United States
(12) Patent Application Publication
(10) Pub. No.: US 2007/0188406 A1
(43) Pub. Date: Aug. 16, 2007

(54) Dual display device

(75) Inventor: Won-Seok Ma, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/705,908

(22) Filed: Feb. 13, 2007

(30) Foreign Application Priority Data
Feb. 14, 2006 (KR) 2006-14007

(51) Int. Cl. G09G 5/00

(52) U.S. Cl. 345/1.1

(57) ABSTRACT

A dual display device includes a first panel, a first driving part, a second display panel, and a second driving part. The first display panel displays a first image, and a the first driving part is formed on the first display panel and outputs a first data signal. The second display panel is electronically connected to the first display panel and displays a second image. The second driving part is formed on the second display panel and outputs a second data signal. The number of the signal conductors connecting the first panel with the second panel is reduced, so that the size of the display device is reduced.

### CROSS-REFERENCE TO RELATED APPLICATIONS

This application relies for priority upon Korean Patent Application No. 2006-14007 filed on Feb. 14, 2006, the contents of which are herein incorporated by reference.

1. Field of the Invention

The present invention relates to a dual display device and, more particularly, to a dual display device having fewer connections between the main and a sub display panel.

2. Description of the Related Art

In general, a mobile phone may be classified as either a flip type or a folder type according to the number of display panels. The flip type has an exposed panel displaying an image whereas the input keys cover the display panel in the folder type. The folder type may have a normal display device or a dual display device having more than one display panel. The dual display device includes a main display panel displaying images and text information and a sub display panel displaying additional information. When the main display panel faces the input keys, the sub display panel is exposed so that call waiting information is displayed even though the main display panel is covered.

The driving circuitry for the mobile phone as well as the small-screen liquid crystal display device may be included on one driving chip, so that the size of the display device and the cost of manufacturing are reduced. The driving chip is mounted on the main panel through tape automated bonding (TAB) or chip on glass (COG) processes.

Moreover, a plurality of data conductors extended from the main display panel to the sub display panel and a plurality of gate conductors extended from the driving part to the sub display panel are formed on a flexible circuit film electrically connecting the main display panel with the sub display panel. Therefore, a plurality of signal conductors is extended from the main display panel, so that widths of the main display panel and the sub display panel are increased. In addition, the number of the signal conductors is increased, so that the design of the main display panel and the sub display panel is complex.

### SUMMARY OF THE INVENTION

In accordance with an aspect of the present invention a dual display device has fewer signal conductors connecting a main display panel with a sub display panel. The main display panel has an image display area and a peripheral area surrounding the display area that includes an integrated first gate driving part that outputs a gate signal to the main display panel and a memory part, a first source driving part and a first timing control part. The memory part stores first and second data signals provided from an external device. The first source driving part converts the first data signal into a first data voltage in analog form and outputs the first data voltage to the first display panel. The first timing control part controls the first source driving part and the first gate driving part based on an original control signal provided from the external device. The first driving part further includes a first voltage generating part providing first driving voltages to the first source driving part and the gate driving part.

Further in accordance with an aspect of the invention, the sub display panel includes a second display area displaying a second image and a second peripheral area surrounding the second display area further including an integrated second gate driving part which outputs a gate signal to the second display panel. The second peripheral area further includes an integrated second voltage generating part that provides second driving voltages to the second source driving and the second gate driving part. The second source driving part converts a second data signal into the second data voltage as an analog form and outputs the second data voltage to the second display panel. The second timing control part controls the second source driving part, the second gate driving part and the second voltage generating part based on the original control signal.

According to another aspect of the invention, the second source driving part includes a sampling part, a digital-analog converting part and an output buffer part. The sampling part samples the second data signal. The digital-analog converting part converts the second data signal into the second data voltage in analog form using a reference gamma voltage provided from the second voltage generating part and outputs the second data voltage. The output buffer part amplifies the second data voltage to a predetermined level and outputs the amplified second data voltage to the second display panel. The second source driving part further includes a level shifter. The level shifter selectively outputs the second data voltages provided from the digital-analog converting part to the output buffer part. The second driving part includes a plurality of polysilicon transistors.

According to the above, the number of the signal conductors connecting panel with panel is reduced, so that the size of the display device is reduced and the productivity of manufacturing the display device is improved.

### BRIEF DESCRIPTION OF THE DRAWING

The above and other objects, features and advantages of the present invention will become readily apparent by reference to the following detailed description when considered in conjunction with the accompanying drawings, in which:

FIG. 1 is a block diagram illustrating a dual display device in accordance with one embodiment of the present invention;

FIG. 2 is plan view illustrating the dual display device of FIG. 1

FIG. 3 is a block diagram illustrating a first driving part illustrated in FIG. 2;

FIG. 4 is a block diagram illustrating a second driving part illustrated in FIG. 2;

FIG. 5 is a block diagram illustrating a second source driving part illustrated in FIG. 4; and

FIG. 6 is a cross-sectional view illustrating the dual display device of FIG. 2.

### DESCRIPTION OF THE EMBODIMENTS

### Dual Display Device

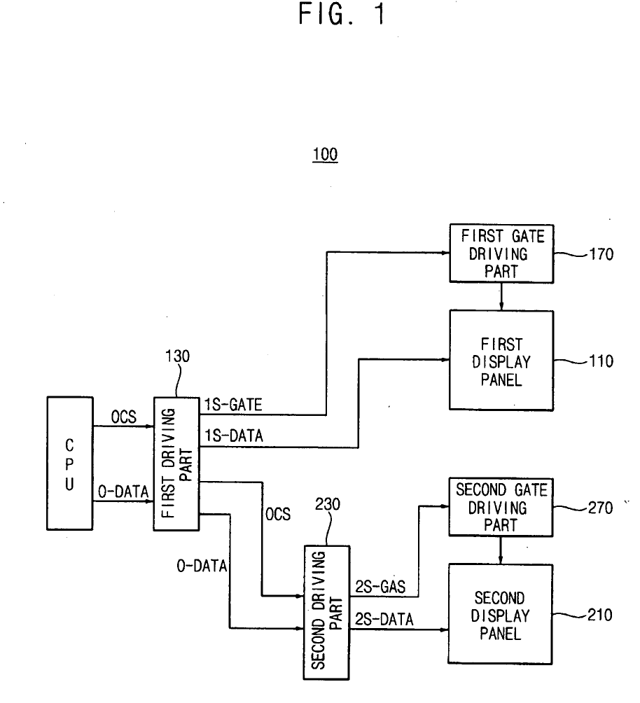

FIG. 1 is a block diagram illustrating a dual display device in accordance with one embodiment of the present invention. Referring to FIG. 1, a dual display device 100 includes a first display panel 110, a first driving part 130, a second display panel 210, and a second driving part 230.

display panel 110 and display panel 210 are driven as an active matrix driving method according to which a pixel is turned on/off by a switching device. display panel 110 displays main information such as image information and text information and display panel 210 displays additional information such as time, date and condition of the battery. display panel 210 is electronically connected to display panel 110 through a connecting part such as a connecting flexible printed circuit board.

driving part 130 is formed on display panel 110, and receives an original image signal O-DATA and an original control signal OCS that are from an external CPU. Driving part 130 outputs a first data voltage 1S-DATA corresponding to a first image to display panel 110 based on the original image signal O-DATA and the original control signal OCS. The dual display device 100 may further include a first gate driving part 170 which is controlled by driving part 130 and outputs a first gate signal 1S-GATE to display panel 110.

Driving part 230 outputs a data voltage 2S-DATA corresponding to a second image to display panel 210 through the connecting flexible printed circuit board based on the original image signal O-DATA and the original control signal OCS. The dual display device 100 may further include a second gate driving part 270 controlled by driving part 230 and outputs a gate signal 2S-GAS to display panel 210.

Driving part 230 and gate driving part 270 are integrated on display panel 210. For example, driving part 230 and gate driving part 270 may be integrated on display panel 210 through a low temperature polysilicon (LTPS) forming method. In the low temperature polysilicon (LTPS) forming method, the polysilicon is formed on display panel 210 at a low temperature so that display panel 210 is not damaged. A switching device formed in a pixel of the display panel 210 and a switching device formed in driving part 230 includes an active layer having polysilicon.

As mentioned in above, driving part 230 outputs data voltage 2S-DATA, and gate driving part 270 outputs gate signal 2S-GAS. Thereby, data conductors and gate conductors may be omitted on the connecting flexible printed circuit board, and the dual display device 100 includes signal conductors applying the original image signal O-DATA and the original control signal OCS to driving part 230.

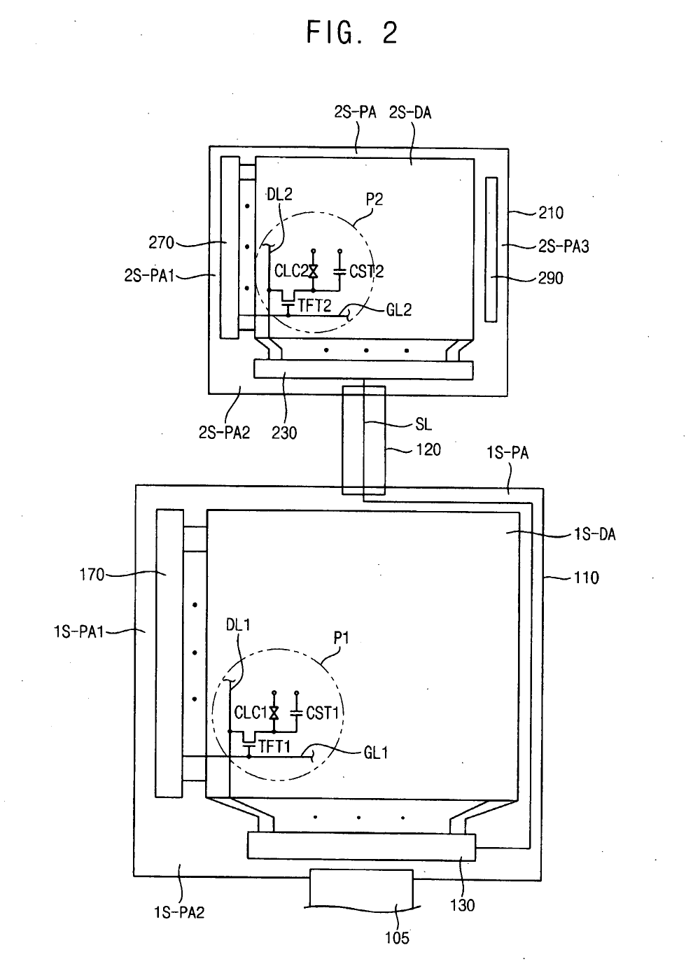

FIG. 2 is a plan view illustrating the dual display device of FIG. 1.

Referring to FIG. 2, display panel 110 includes a lower substrate, an upper substrate and a liquid crystal layer disposed between the lower substrate and upper substrate. display panel 110 may be divided into a first display area 1S-DA and a first peripheral area 1S-PA surrounding display area 1S-DA.

A plurality of data conductors DL1 and a plurality of gate conductors GL1 crossing the data conductors DL1 are formed on the lower substrate corresponding to display area 1S-DA. A plurality of pixel portions P1 is defined by the data conductors DL1 and the gate conductors GL1. A switching device TFT1, a liquid crystal capacitor CLC1 electronically connected to the switching device TFT1 and a storage capacitor CST1 are formed in each of the pixel portions P1.

A first peripheral area 1S-PA1 is adjacent to display area 1S-DA along a direction in which the gate conductors GL1 are extended. A second peripheral area 1S-PA2 is adjacent to display area 1S-DA along a direction in which data conductors DL1 are extended.

Display panel 110 is electronically connected to the external device CPU through an input flexible printed circuit board 105. Gate driving part 170 is formed in peripheral area 1S-PA1 and outputs gate signal 1S-GATE to the gate conductors GL1 under control of driving part 130 which is formed in peripheral area 1S-PA2. Driving part 130 outputs data voltage 1S-DATA to the data conductors DL1 based on the original image signal O-DATA and original control signal OCS.

In FIG. 2, gate driving part 170 and driving part 130 are shown as different chips. In an alternative embodiment, driving part 130 and gate driving part 170 may be integrated into one unified chip. In another embodiment, driving part 130 and gate driving part 170 may be integrated through a low temperature polysilicon (LTPS) forming method in display panel 110 on the lower substrate.

Display panel 210 includes a lower substrate, an upper substrate and a liquid crystal layer disposed between the lower substrate and upper substrate. Display panel 210 includes a display area 2S-DA and a peripheral area 2S-PA surrounding display area 25-DA.

A plurality of data conductors DL2 and a plurality of gate conductors GL2 crossing the data conductors DL2 are formed on the lower substrate corresponding to display area 2S-DA. A plurality of pixel portions P2 are defined by data conductors DL2 and gate conductors GL2. A switching device TFT2, a liquid crystal capacitor CLC2 electronically connected to the switching device TFT2, and a storage capacitor CST2 are formed in each of pixel portions PS2.

Of peripheral areas 2S-PA1, 2S-PA2, 2S-PA3, area 2S-PA1 is adjacent to display area 2S-DA along the direction in which gate conductors GL2 are extended. Area 2S-PA2 is adjacent to display area 2S-DA along the direction in which data conductors DL2 are extended. Area 2S-PA3 is adjacent to an opposite side of display area 2S-DA from area 2S-PA1.

Signal conductors SL electrically connecting driving part 130 with driving part 230 are formed on the connecting flexible printed circuit board 120.

Gate driving part 270 is integrated in area 2S-PA1 and outputs gate signal 2S-GAS to gate conductors GL2 under control of driving part 230. Driving part 230 is formed in area 2S-PA2 and outputs data voltage 2S-DATA to the data conductors DL2 based on the original image signal O-DATA and the original control signal OCS.

In FIG. 2, gate driving part 270 and driving part 230 are integrated in area 2S-PA on the lower substrate of display panel 210 during the process of forming data conductors DL2, gate conductors GL2 and switching devices TFT2. For example, when pixel portions P2 are formed by polysilicon (poly-Si), driving part 230, and gate driving part 270 are integrated simultaneously on the lower substrate corresponding to peripheral area 2S-PA.

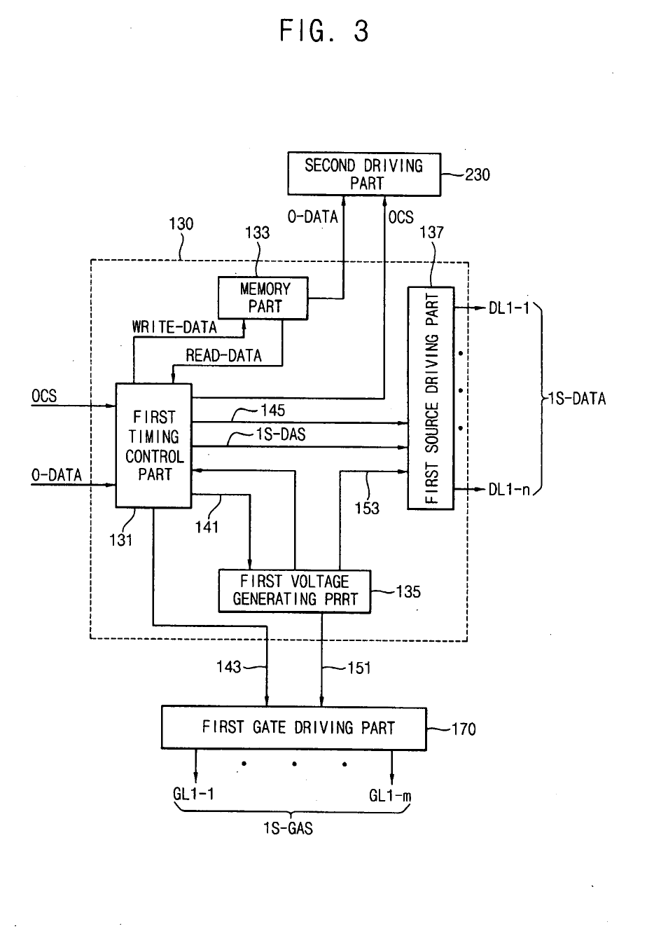

FIG. 3 is a block diagram illustrating a first driving part illustrated in FIG. 2. Referring to FIG. 3, driving part 130 includes timing control part 131, memory part 133, voltage generating part 135 and source driving part 137.

Timing control part 131 receives an original image signal O-DATA and an original control signal OCS from the external device CPU and stores the original image signal O-DATA and the original control signal OCS in memory part 133 (WRITE-DATA). The original image signal O-DATA includes a first data signal corresponding to image and a second data signal corresponding to image. The timing control part 131 reads data signal from memory part 133 in response to the original control signal OCS at a proper time, for example, line by line (READ-DATA).

Memory part 133 includes a main storage area and a sub storage area. Memory part 133 stores data signal 1S-DAS from timing control part 131 in the main storage area and selectively stores data signal in the sub storage area.

Timing control part 131 generates and outputs first, second and third control signals 141, 143 and 145 based on the original control signal OCS. For example, timing control part 131 applies main control signal 141 to voltage generating part 135, and applies main control signal 143 to gate driving part 170. In addition, timing control part 131 also applies the third main control signal 145 and data signal 1S-DAS to source driving part 137, and controls the driving of voltage generating part 135, gate driving part 170 and source driving part 137.

Voltage generating part 135 outputs driving voltages corresponding to main control signal 141 to drive the dual display device 100. For example, voltage generating part 135 outputs main driving voltages 151 to gate driving part 170, and outputs main driving voltages 153 to source driving part 137. In addition, voltage generating part 135 also outputs a third main driving voltage to display panel 110.

Main driving voltages 151 include a gate on voltage VDD and a gate off voltage VSS to generate gate signal 1S-GATE. Main driving voltages 153 include an analog driving voltage AVDD, a digital driving voltage DVDD and reference gamma voltages VREF. The third main driving voltages include common voltages VCOM and VST applied to the liquid crystal capacitor CLC1 and storage capacitor CST1.

Gate driving part 170 generates gate signal 1S-GATE based on main control signal 143 and the main driving voltages 151 from driving part 130. Gate driving part 170 outputs gate signal 1S-GATE to the gate conductors GL2.

Source driving part 137 converts data signal 1S-DAS into a first data voltage 1S-DATA in analog form based on the third main control signal 145 and main driving voltages 153 that are from driving part 130. Source driving part 137 outputs data voltage 1S-DATA to data conductors DL1.

Driving part 130 transfers the original control signal OCS and the original image signal O-DATA to driving part 230. The original control signal OCS and the original image signal O-DATA are transferred to driving part 230 through signal conductors SL formed on the connecting flexible printed circuit board 120.

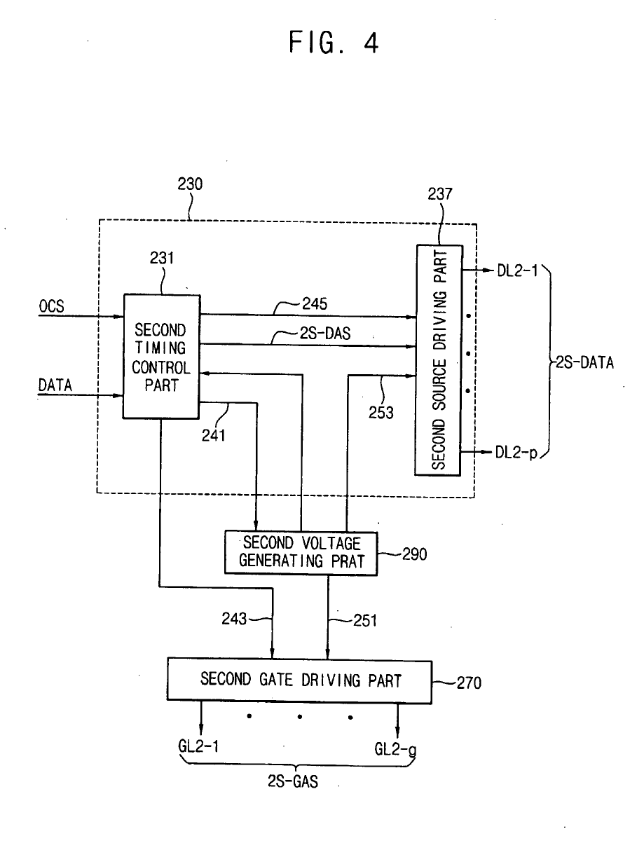

FIG. 4 is a block diagram illustrating a second driving part illustrated in FIG. 2. Referring to FIG. 4, driving part 230 includes a second timing control part 231 and a second source driving part 237.

Timing control part 231 receives the original image signal O-DATA and the original control signal OCS through the connecting flexible printed circuit board 120. For example, timing control part 231 reads data signal 2S-DAS from memory part 133 based on the original control signal OCS in a proper time.

Referring FIGS. 2 and 4, the dual display device 100 may further include a second voltage generating part 290 which is integrated in peripheral area 2S-PA3. Voltage generating part 290 outputs driving voltages to drive the dual display device 100 under the control of timing control part 231.

Timing control part 231 generates and outputs a first sub control signal 241, a second sub control signal 243 and a third sub control signal (not shown) based on the original control signal OCS. For example, timing control part 231 applies sub control signal 241 to generating part 290, and applies sub control signal 243 to gate driving part 270. In addition, timing control part 231 applies the third sub control signal 245 and data signal 2S-DAS to source driving part 237 and controls the driving of generating part 290, gate driving part 270 and source driving part 237.

The original control signal OCS includes horizontal and vertical synchronizing signals HSYNC and VSYNC, a main clock signal MCK and a data enable signal DE. Sub control signal 241 includes the main clock signal MCK. sub control signal 243 includes a vertical start signal STV. Sub control signal 245 includes a horizontal start signal STH, a latch signal LOE and a load signal TP.

Voltage generating part 290 outputs a first sub driving voltage 251, a second sub driving voltage 253 and a third sub driving voltage (not shown) under control of sub control signal 243. For example, voltage generating part 290 outputs sub driving voltages 251 to gate driving part 270, and outputs sub driving voltages 253 to source driving part 237. In addition, voltage generating part 290 also outputs a sub driving voltage to display panel 210.

Sub driving voltages 251 include a gate-on voltage VDD and a gate-off voltage VSS to generate gate signal 2S-GAS. Sub driving voltages 253 include an analog driving voltage AVDD, a digital driving voltage DVDD and reference gamma voltages VREF. The third sub driving voltages include common voltages VCOM and VST applied to the liquid crystal capacitor CLC and the storage capacitor CST of display panel 210.

Gate driving part 270 generates gate signal 2S-GAS based on sub control signal 243 from driving part 230 and sub driving voltages 253 from voltage generating part 290. Gate driving part 270 outputs gate signal 2S-GAS to gate conductors GL2 formed in display area 2S-DA of display panel 210.

Source driving part 237 converts data signal 2S-DAS into a second data voltage 25-DATA in analog form based on sub control signal 245 and sub driving voltage 253 from driving part 230. Source driving part 237 outputs data voltage 2S-DATA to source wirings DL2.

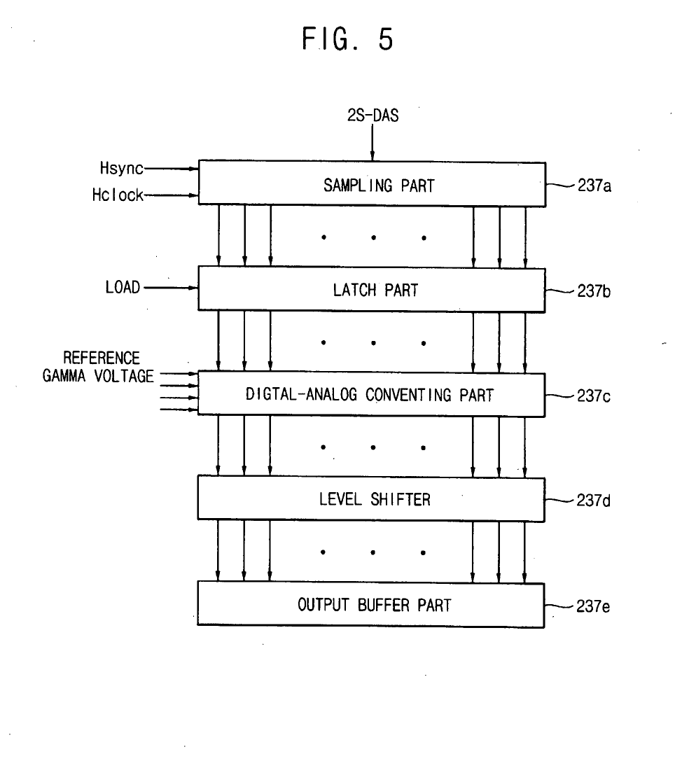

FIG. 5 is a block diagram illustrating a second source driving part illustrated in FIG. 4. Referring to FIG. 5, source driving part 237 includes a sampling part 237A, a latch part 237B, a digital-analog converting part 237C, a level shifter 237 D, and an output buffer part 237E.

The sampling part 237A samples data signal 2S-DAS based on the original control signal OCS and the third sub control signal 245.

When the latch signal LOE is input to latch part 237B, latch part 237B latches the sampled second data signal 2S-DAS for a predetermined time. When the load signal LOAD is input to latch part 237B, latch part 237B outputs data signal 2S-DAS to the digital-analog converting part 237C.

The digital-analog converting part 237C converts data signal 2S-DAS into data voltage 2S-DATA in analog form using the reference gamma voltage from voltage generating part 290.

Level shifter 237D selectively outputs data voltages 2S-DATA provided from digital-analog converting part 237C. Output buffer part 237E amplifies data voltage 2S-DATA to a predetermined level and outputs to display panel 210.

In FIG. 5, gate driving part 270, driving part 230 and voltage generating part 290 are respectively integrated in peripheral areas 2SPA1, 2S-PA2 and 25-PA3. However, gate driving part 270, driving part 230, and voltage generating part 290 may be integrated into one unified area. In addition, the location of the integration may be changed as desired.

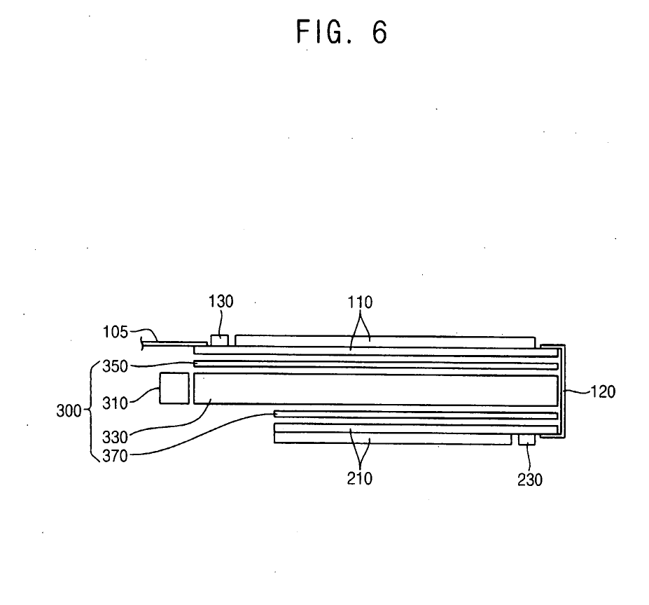

FIG. 6 is a cross-sectional view illustrating the dual display device of FIG. 2. Referring to FIG. 6, the connecting flexible printed circuit board 120 is bent, so that display panel 110 and display panel 210 face each other. display area 1S-DA of display panel 110 and display 2S-DA of display panel 210 face each other in opposite directions.

The dual display device 100 may further include a backlight assembly 300. The backlight assembly 300 is disposed between display panel 110 and display panel 210, and generates light, so that each of display panel 110 and display panel 210 respectively displays each of image and image based on the light generated from the backlight assembly 300.

The backlight assembly 300 includes a light source 310, a light guide unit 330, a first optical sheet 350, and a second optical sheet 370. The light source 310, for example, may include a light emitting diode. The light guide unit 330 receives the light generated from the light source through a side surface of the light guide unit 330, and guides the light toward display panel 110 and display panel 210.

Optical sheet 350 is disposed between display panel 110 and the light guide unit 330, and improves optical characteristics of the light exiting the light guide unit 330, such as the uniformity of brightness and front brightness.

Optical sheet 370 is disposed between display panel 210 and the light guide unit 330, and improves optical characteristics of the light exiting the light guide unit 330, such as the uniformity of brightness and front brightness.

According to the present invention, a timing control part, a voltage generating part, a gate driving part and a source driving part are integrated in display panel through the low temperature polysilicon forming method. Thereby, the data conductors formed in one display panel are not extended to the other display panel. Moreover, a gate signal can be applied to a plurality of the gate conductors formed in the second display panel even though a plurality of signal conductors extended from the driving part are not extended to the second display panel. Therefore, the number of signal conductors connecting the first display panel with the second display panel is reduced, so that the size of the first display panel and second display panel is reduced and the productivity of the dual display device is improved.

Although the exemplary embodiments of the present invention have been described, it is understood that the present invention should not be limited to these exemplary embodiments but various changes and modifications can be made by one ordinary skilled in the art within the spirit and scope of the invention.

What is claimed is:

1. A dual display device comprising:
a first display panel displaying a first image;
a first driving part formed on the display panel for providing a first image data voltage to the first display panel;
a second display panel electronically connected to the first display panel for displaying a second image; and
a second driving part formed on the second display panel for applying a second image data voltage to the second display panel.

2. The display device of claim 1, wherein the first display panel includes a first display area displaying the first image and a peripheral area surrounding the first display area, and a first gate driving part integrated in the peripheral area for applying a gate signal to the first display panel.

3. The display device of claim 2, wherein the first driving part is formed in the peripheral area of the first display panel.

4. The display device of claim 3, wherein the first driving part comprises:
a memory part storing first and second data signals;
a first source driving part converting the first data signal into the first data voltage in analog form and outputting the first data voltage to the first display panel; and
a first timing control part controlling the first source driving part and the first gate driving part based on an original control signal.

5. The display device of claim 4, wherein the first driving part comprises a unified chip located in the peripheral area.

6. The display device of claim 5, wherein the first driving part further comprises a first voltage generating part applying first driving voltages to the first source driving part and the gate driving part.

7. The display device of claim 1, wherein the second display panel includes a second display area displaying an image and a peripheral area surrounding the second display area, and a second gate driving part integrated in the peripheral area of the second display panel for applying a gate signal to the second display panel.

8. The display device of claim 7, wherein the second driving part is integrated in the peripheral area of the second display panel.

9. The display device of claim 8, further comprising a second voltage generating part that is integrated in the peripheral area of the second display panel for providing second driving voltages to the second source driving part and the second gate driving part.

10. The display device of claim 9, wherein the second driving part comprises:
a second source driving part converting a second data signal into the second data voltage in analog form for applying a data voltage to the second display panel; and
a second timing control part controlling the second source driving part, the second gate driving part and the second voltage generating part based on an original control signal.

11. The display device of claim 10, wherein the second source driving part comprises:
a sampling part sampling the second data signal;
a digital-analog converting part converting the second data signal into the second data voltage in analog form using a reference gamma voltage provided from the second voltage generating part; and
an output buffer part amplifying the second data voltage to a predetermined level and outputting the amplified second data voltage to the second display panel.

12. The display device of claim 11, wherein the second source driving part further comprises a level shifter selectively outputting the second data voltages to the output buffer part.

13. The display device of claim 12, wherein the second driving part comprises a plurality of polysilicon transistors.

14. A dual display device comprising:
a display panel displaying a first image based on a first driving signal;
a display panel displaying a second image based on a second driving signal;
a first driving part formed in the first display panel and including a memory part storing a received original image signal and generating a first driving signal, the first driving signal including a first image signal based on a synchronizing signal of the original image signal and a first control signal controlling the application time of the first image signal to the first display panel;
a connecting part electronically connecting the first display panel with the second display panel; and
a second driving part formed in the second display panel and generating the second driving signal based on the original image signal and the synchronizing signal from the memory part through the connecting part, the second driving signal including a second image signal and a second control signal that controls the application time of the second image signal to the second display panel.

15. The display device of claim 14, wherein the first driving part comprises:
a first source driving part outputting a first source signal to the first display panel based on the first control signal and the first image signal;
a first gate driving part outputting a first gate signal to the first display panel based on the first control signal;
a first timing control part outputting the first control signal and the first image signal to the first source driving part and outputting the first control signal to the first gate driving part based on the synchronizing signal; and
a first voltage generating part applying the first driving voltages to the first timing control part, the first source driving part, the first gate driving part and the first display panel based on the first voltage control signal provided from the first timing control part.

16. The display device of claim 14, wherein the second driving part is integrated on the second display panel, and comprises:
a second source driving part outputting a second source signal to the second display panel based on the second control signal and the second image signal;
a second gate driving part outputting the second gate signal to the second display panel based on the second control signal;
a second timing control part outputting the second control signal and the second image signal to the second source driving part and outputting the second control signal to the second gate driving part based on the synchronizing signal of the original image signal; and
a second voltage generating part applying second driving voltages applied to the second timing control part, the second source driving part, the second gate driving part and the second display panel based on a second voltage control signal from the second timing control part.
